(19) United States
(12) Patent Application Publication
(10) Pub. No.: US 2020/0230660 A1
(43) Pub. Date: Jul. 23, 2020

(54) IN-SITU TRANSPORT CLEANING

(71) Applicant: Xerox Corporation, Norwalk, CT (US)

(72) Inventors: Peter J. Nystrom, Webster, NY (US); Christopher Mieney, Rochester, NY (US); David VanKouwenberg, Avon, NY (US); Mark A. Cellura, Webster, NY (US)

(21) Appl. No.: 16/252,507

(22) Filed: Jan. 18, 2019

(51) Int. Cl. B08B 3/04; B08B 1/00; B08B 1/04; B08B 1/02; B08B 5/04; B41J 29/17

(52) U.S. Cl. CPC B08B 3/041; B08B 1/001; B41J 29/17; B08B 1/02; B08B 5/043; B08B 1/04

(57) ABSTRACT

A system, method and apparatus for in-situ cleaning comprises a shower configured to dispense cleaning solution on a belt in a rendering device a dryer configured down line from the shower; a cleaning roller configured to engage a transport roller associated with the belt and a control system for controlling operations thereof.

### TECHNICAL FIELD

Embodiments are generally related to the field of rendering devices. Embodiments are further related to the field of rendering device maintenance. Embodiments are also related to methods, systems, and devices for cleaning components in rendering devices. Embodiments are related to methods, systems, and devices for in-situ flushing and drying of photoreceptor belts. Embodiments are further related to methods, systems, and devices for in-situ cleaning of web transport mechanisms using separable cleaning solutions. Embodiments are also related to methods, systems, and devices for in-situ cleaning of web transport mechanisms using a liquid wave.

### BACKGROUND

Printing remains a critically important function in the modern workplace and home alike. Printers, and in particular ink jet printers, are commonly used for business applications and for simple home printing applications.

In large ink jet printers that employ vacuum belt transports, the belt can become contaminated with ink and debris. Such fouling can lead to system faults such as motion quality errors and paper handling issues. Currently, the belt must be periodically removed from the printer and cleaned, to avoid such errors. This leads to system downtime and increases the risk of damage to components. As the size of the transport components increase, these problems quickly become unmanageable.

Similarly, photoreceptor belts, used in certain printing applications, can become contaminated with ink. Ink contamination can lead to loss of belt tracking, velocity errors, and paper jams. Once again, the current solution is to remove the belt from the rendering device, clean it, and then reinstall it in the machine. This becomes particularly vexatious as rendering devices are scaled to accommodate larger paper sizes. Larger marker transports make the feasibility of belt removal for cleaning less practical.

Accordingly, there is a need in the art for methods and systems that facilitate in-situ cleaning solutions as described in the embodiments disclosed herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for rendering device maintenance.

It is another aspect of the disclosed embodiments to provide a method, system, and apparatus for printer maintenance and cleaning.

It is another aspect of the disclosed embodiments to provide a method, system, and apparatus for cleaning transport belts.

It is another aspect of the disclosed embodiments to provide in-situ web cleaning using a liquid wave.

It is another aspect of the disclosed embodiments to provide in-situ cleaning of vacuum belt transports.

It is another aspect of the disclosed embodiments to provide in-situ flushing and drying of photoreceptor belts.

In the embodiments disclosed herein an in-situ cleaning system comprises a shower configured to dispense cleaning solution on a belt, a dryer configured down line from the shower, and at least one cleaning roller configured to engage a transport roller associated with the belt. The system further comprises at least one ultrasonic device disposed in cleaning solution associated with a transport. The system further comprises a controller, the controller comprising: at least one processor; and a computer-usable medium embodying computer program code, the computer-usable medium capable of communicating with the at least one processor, the computer program code comprising instructions executable by the at least one processor and configured for controlling at least one of: dispensation associated with the shower, operation of the dryer, engagement of the at least one cleaning roller, and operation of the ultrasonic device. The controller can operate in one of an automatic mode and a manual mode. The dryer comprises one of a wiper, an air knife, and a vacuum. The system further comprises a drip pan configured beneath the belt to collect residual cleaning solution, and a pump disposed in the drip pan configured to pump the residual cleaning solution to the shower. The at least one cleaning roller further comprises: a rotational hub, an interior body, and an exterior cleaning surface. The system further comprises a housing wherein the shower, the dryer, and the at least one cleaning roller are housed and at least one mounting fixture for fixedly mounting the housing to a rendering device. The belt comprises a transport belt associated with a rendering device.

A method for in-situ cleaning comprises dispensing a cleaning solution on a belt, removing the cleaning solution from the belt with a dryer configured down line from the dispensed cleaning solution, and cleaning a transport roller with at least one cleaning roller engaged against the transport roller. The method further comprises agitating cleaning solution disposed in a marker transport with at least one ultrasonic device. The method further comprises controlling, with a controller, at least one of: dispensation associated with the shower, operation of the dryer, engagement of the at least one cleaning roller, and operation of the ultrasonic device. The controller can operate in one of an automatic mode, and a manual mode. The dryer comprises one of a wiper, an air knife, and a vacuum. The method further comprises collecting residual cleaning solution with a drip pan configured beneath the belt, and pumping the collected residual cleaning solution to a reservoir with a pump disposed in the drip pan. The at least one cleaning roller further comprises a rotational hub, an interior body, and an exterior cleaning surface. The method further comprises mounting a housing wherein the reservoir, the dryer, and the at least one cleaning roller are housed to a rendering device.

In another embodiment a system comprises a cleaning solution reservoir filled with cleaning solution, a ducted output structure configured in the cleaning solution reservoir, and a pump configured to pump cleaning solution in the cleaning solution reservoir through an opening of the ducted output structure wherein the cleaning solution exiting the ducted output structure contacts a belt. The system further comprises a dryer downline from the ducted output structure. The dryer comprises one of a wiper, an air knife, and a vacuum.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 illustrates a computer software system for directing the operation of the data-processing system depicted in FIG. 1, in accordance with an example embodiment;

FIG. 4 depicts a block diagram of an in-situ cleaning system, in accordance with the disclosed embodiments;

FIG. 5 depicts a block diagram of an in-situ cleaning system, in accordance with the disclosed embodiments;

FIG. 6 depicts a block diagram of an in-situ cleaning system, in accordance with disclosed embodiments;

FIG. 7 depicts a block diagram of a wave-based in-situ cleaning system, in accordance with disclosed embodiments;

FIG. 8 depicts a block diagram of a wave-based in-situ cleaning system, in accordance with disclosed embodiments;

FIG. 9 depicts a removable in-situ cleaning system, in accordance with the disclosed embodiments; and

FIG. 10 depicts a flow chart of steps associated with a method for cleaning a rendering device, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, Aft AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, Aft BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

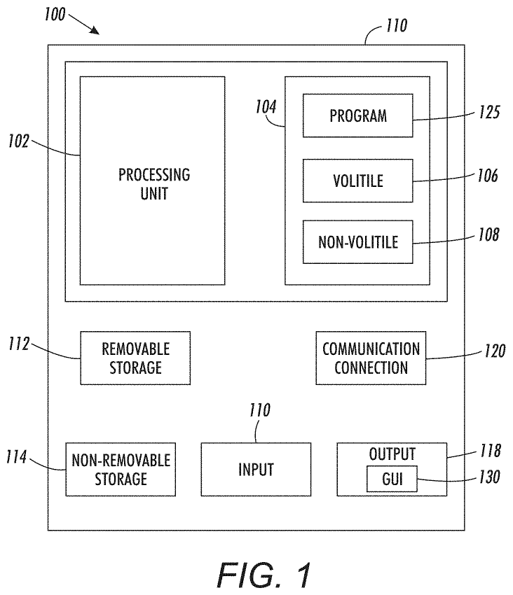

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with controllers, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage as described herein includes, for example, disc storage, disk storage, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Discs (DVD) or other optical disc storage, magnetic cassettes, magnetic tape, magnetic disk storage, or other magnetic storage devices, or any other medium capable of storing computer-readable instructions as well as data including image data.

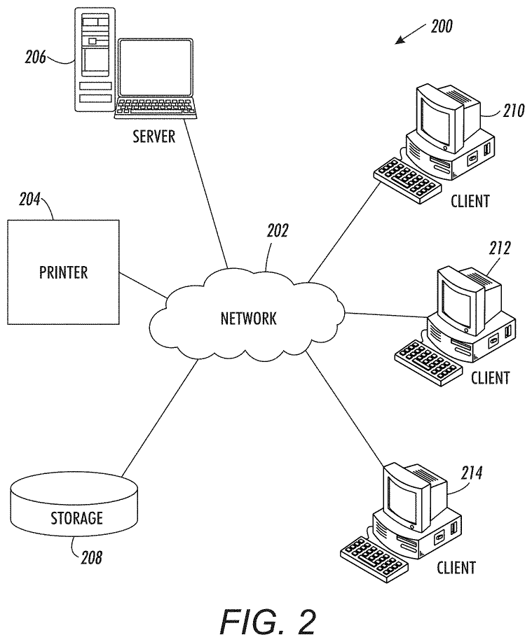

Computer 110 may include, or have access to, a computing environment that includes input 116, output 118, and a communication connection 120. The computer may operate in a networked environment using a communication connection 120 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection 120 may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device, such as input 116 which can be embodied, for example, as a pointing device such as a mouse, and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 can be a network of computers or other such devices, such as mobile phones, smart phones, sensors, controllers, speakers, tactile devices, and the like, in which embodiments of the present invention may be implemented. Note that the system data-processing system 200 can be implemented in the context of a software module, such as module 125. The data-processing system 200 includes a network 202 in communication with one or more clients 210, 212, and 214. Network 202 may also be in communication with one or more printing devices 204, servers 206, and storage 208. Network 202 is a medium that can be used to provide communications links between various devices and computers connected together within a networked data processing system such as computer system 100. Network 202 may include connections such as wired communication links, wireless communication links of various types, and fiber optic cables. Network 202 can communicate with one or more servers 206, one or more external devices such as multifunction device or printer 204, and storage 208, such as a memory storage unit, for example, a memory or database. It should be understood that printing device 204 may be embodied as a printer, copier, fax machine, scanner, multifunction device, rendering machine, photo-copying machine, or other such rendering device.

In the depicted example, printer 204, server 206, and clients 210, 212, and 214 connect to network 202 along with storage 208. Clients 210, 212, and 214 may be, for example, personal computers or network computers, handheld devices, mobile devices, tablet devices, smart phones, personal digital assistants, printing devices, recording devices, speakers, MFDs, etc. Computer system 100 depicted in FIG. 1 can be, for example, a client such as client 210 and/or 212 and/or 214.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and printing device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet, with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

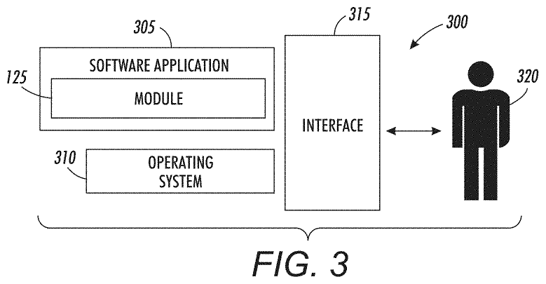

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the computer system 100. The computer system 100 can receive user commands and data through interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” type system, such as Microsoft Windows®. It can be appreciated, of course, that other types of systems are possible. For example, rather than a traditional “windows” system, other operation systems such as, for example, a real-time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of, a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

The embodiments disclosed herein are drawn to methods and systems for cleaning components in a rendering device. In one such embodiment, an in-situ cleaning station for the photoreceptor belt is described. In such an embodiment, cleaning solution can be applied via a nozzle, shower or the like. The marker transport can be closed off and filled with cleaning solution to clean the transport. Ultrasonic devices can be added to aid in the cleaning of the transport and belt. Furthermore, brushes or scrubbers can be added to clean the rollers that steer and drive the belt. Cleaning solution can be provided that include one or more of alcohol, water, ink jet flush, etc. In addition, a squeegee blade, air knife, a vacuum, the transport vacuum, or any such combination, can be used to remove the liquid from the belt, so that it is dry prior to contact with process paper.

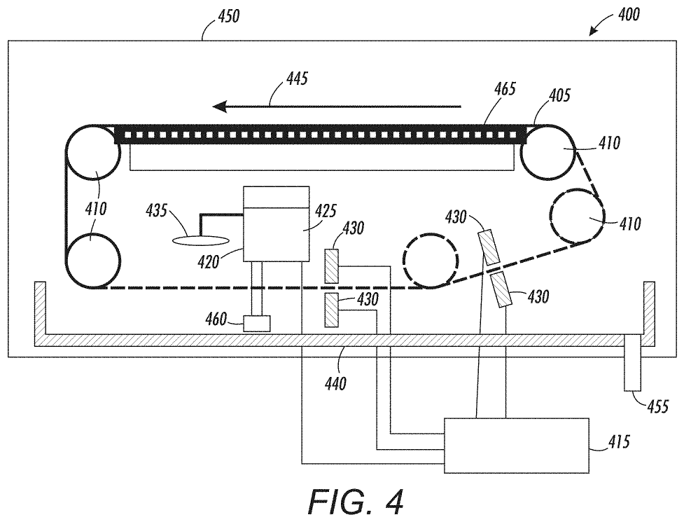

An embodiment of a cleaning system 400 associated with a rendering system 450 is illustrated in FIG. 4. As contamination of the belt 405 (e.g. a marker belt, vacuum transport belt, etc.) and marker transport 465 occurs, an automated, semi-automated, or manual cleaning routine can be implemented with control system 415. Note that control system 415 can comprise a computer system such as computer system 100 illustrated in FIG. 1 above. The control system 415 can provide continuous automated operation, or can be controlled and run manually using a GUI, when contamination of the belt 405 and marker transport 465 makes cleaning necessary.

As illustrated in FIG. 4, a shower 435 can be connected to reservoir 420 filled with cleaning solution 425. The reservoir can be operably connected to the control system 415. The cleaning solution 425 can comprise, alcohol, water, ink jet flush, or other such cleaning agent. The shower 435 can comprise a shower, nozzle, or other such device that applies cleaning solution 425, as a spray or deluge, to the belt 405. The spray can be applied to the drive side, or inner side, of the belt 405 as illustrated in FIG. 4. In other embodiments, additional showers 435 can be applied, some of which may also apply cleaning solution on the product side, or outer side, of the belt 405.

A drip pan 440 can be provided below the shower 435 and belt 405 to collect excess cleaning solution 425. The drip pan 440 can be configured with a pump and conduit assembly 460 to recycle cleaning solution 425 if necessary. The drip pan 440 can also include a drain 455 to allow contaminated cleaning solution 425 to be drained from the cleaning system 400.

The cleaning system 400 can further comprise one or more dryers 430. It should be noted that the belt 405 can move with assistance from transport rollers 410 (e.g. the drive roller, idler roller and steering roller), counter clockwise as indicated by arrow 445. The dryers 430 are can be arranged after the shower 435 but before the marker transport 465, where substrate marking occurs. The dryers 430 can be wipers, air knives, vacuums or a combination thereof. The dryers 430 can be connected to the control system 415 which can signal the dryers 430 to turn on and off as necessary to dry the belt 405.

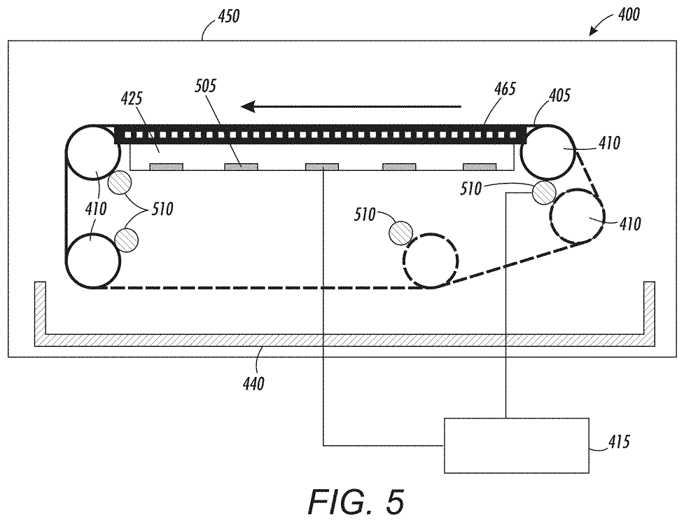

FIG. 5 illustrates an embodiment in which the marker transport 465 can also be filled with cleaning solution 425. In such embodiments, the belt 405 can run across the marker transport 465 as cleaning solution contained in the marker transport is agitated, in order to clean platen, and other fouling that occurs therein.

Ultrasonic devices 505 can be included in the marker transport 465. The ultrasonic devices 505 can comprise pucks configured to vibrate at ultrasonic frequencies. The ultrasonic devices 505 can be used to agitate the cleaning solution 425 which can aid in cleaning the fouling (e.g. platen) in the marker transport 465. The ultrasonic devices 505 can also serve to create a mist of cleaning solution 425, through which the belt 405 passes. It should be appreciated that the number of ultrasonic devices 505 can be selected according to the size of the marker transport 465.

Ultrasonic devices 505 can be any device that creates high-frequency pressure waves above 15000 Hz. The ultrasonic devices 505 can include onboard power. The ultrasonic devices 505 can be connected to control system 415, such that the ultrasonic devices 505 are turned on and off automatically or manually. In certain embodiments, the control system 415 can be used to achieve temporally predetermined activation of certain of the ultrasonic devices 505, to provide a desired agitation of the cleaning solution 425 and/or to create the desired misting pattern through which the belt 405 passes.

In certain embodiments, cleaning rollers 510 can also be engaged against the transport rollers 410 in the rendering device 450 (e.g. a print system). The cleaning rollers 510 can include an external cleaning surface, interior body and rotational hub. Each of the transport rollers 410 can have a cleaning roller 510 proximally located such that the cleaning surface of the cleaning roller, is in contact with the transport roller 410. As the transport roller 410 turns, the cleaning roller 510 also spins thereby cleaning the transport roller 410.

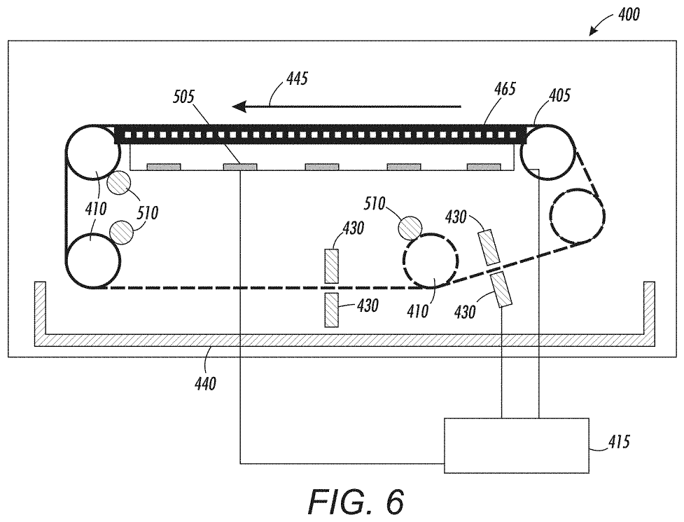

Post cleaning, the marker transport 465 can be drained. The dryer 430 (e.g. a vacuum dryer) can be used to dry the belt 405 as it runs over the marker transport 465. Thus, in some circumstances a liquid trap and cleaning rollers 510 can be periodically inspected and replaced. It should be understood that any combination or part of these concepts can be utilized to achieve cleaning of the belt 405, marker transport 465, and transport rollers 410, as illustrated in FIG. 6.

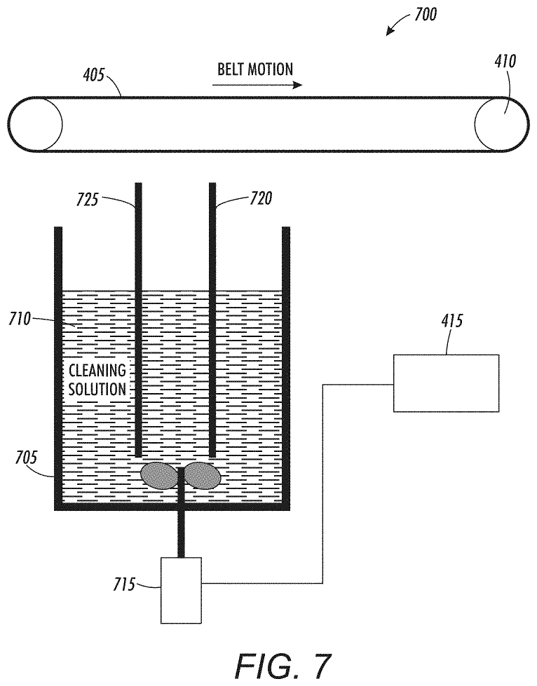

In another embodiment an in-situ cleaning of the vacuum transport belt can be achieved with a system 700, as illustrated in FIG. 7. In this embodiment, a controlled liquid wave of cleaning solution 710 can be brought into contact with the belt 405 while the belt is moving. Residual cleaning solution 710 can be removed from the belt 405 via a vacuum or other such means.

The system 700 comprises a reservoir 705 of cleaning solution 710 with a pump 715 connected to a ducted output structure 720. The shape of the ducted output structure 720 can be chosen to create a wave-like output at the duct opening 725 of cleaning solution 710. The pump 715 creates a flow out of the duct opening 725 causing a wave of cleaning solution 710 to rise and spill over the ducted output structure 720 and back into the reservoir 705. This wave can be brought into contact with a desired surface, to apply liquid and/or to perform a function, in this case cleaning.

The ducted output structure 720 can be located below the surface to be wetted and cleaned (e.g. belt 405), with clearance so that there is no mechanical interference or contact between the ducted output structure 720 and the belt 405.

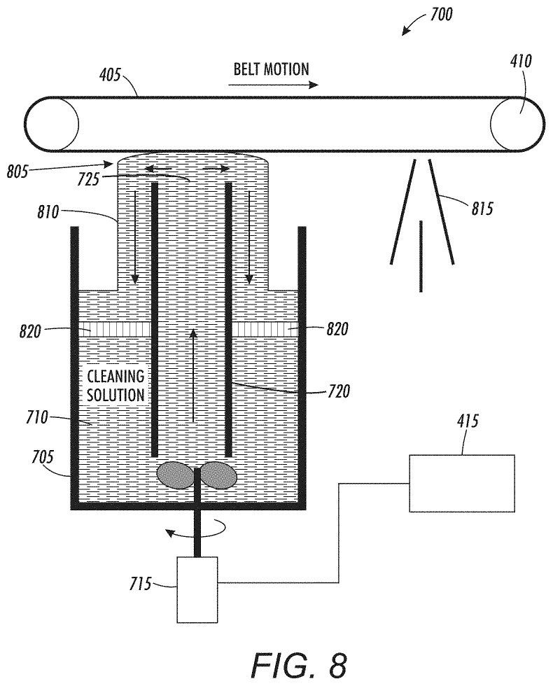

As illustrated in FIG. 8, when the pump 715 is turned on, the pump 715 draws in cleaning solution 710 from the reservoir 705 and pressurizes the ducted output structure 720. This causes an upward liquid flow of the cleaning solution 710 in the ducted output structure 720 and a resultant wave 805 that exits the duct opening 725 of the ducted output structure 720. This protruding wave 805 contacts the bottom of the belt 405 (or other such surface to be wetted and cleaned). Excess material, such as used cleaning solution 810 flows or drips off the belt 405, back into the reservoir 705 adjacent to the ducted output structure 720. The re-collected cleaning solution 710 can be discarded or recirculated.

Optionally, the system 700 can be employed in conjunction with a companion system to vacuum or otherwise draw off excess cleaning solution. This can include, any of the additional embodiments disclosed herein, or other such drying mechanisms. In other embodiments, multiple cleaning systems with differing cleaning solutions can be applied using a system 700.

It should be noted that, in FIGS. 7 and 8, the pump 715 is shown as being submerged in the reservoir 705, but this does not preclude an external pump (or pumps) with plumbing to facilitate cleaning solution flow. In certain embodiments, baffles and/or other structures to create uniform flow across the wave 805 can be included in the ducted output structure 720.

It should be noted that the solution that flows into the pump 715 and through the ducted output structure 720 that forms the wave 805 need not be drawn from the surface of the cleaning solution 710 in the reservoir 705. As such, floating debris is not introduced into the cleaning flow. In certain embodiments, a filter 820 can be used to remove submerged or suspended contaminants in the cleaning solution 710. In addition, the use of the liquid wave 805 does not require a consumable wiping material, nor does the wave impart friction on the belt 405.

In certain embodiments, a control system 415 can be used to control the pressure and/or flow of the wave 805. The pressure and flow of the wave 805 can be adjusted to penetrate vacuum holes or slots, associated with the rendering system 450, as necessary to rinse and clean them. The cleaning effectiveness can be adjusted with the control system 415, based on time.

As shown in FIG. 8, to remove excess material from the belt 405, a vacuum 815 (or other such mechanism for removing cleaning solution 710 can be employed.

The embodiments do not require mechanical contact or wiping, and minimize cross contamination. Cleaning solutions can be adjusted to match desired ink chemistry. Additionally, the wave 805 allows in place cleaning without removing belt transport components. Reduced spraying and forced flow minimizes or eliminates contamination elsewhere within the rendering device.

In another embodiment, a stand-alone (and separable) cleaning station that docks with the printer transport can be used to clean various components of the rendering device as a dedicated task. Such a system provides in-situ cleaning of the vacuum transport belt, without removal of the belt. The system can be removable such that a single system can be used to service multiple rendering devices and can minimize the risk of damaging components. In certain embodiments, the system can optionally be used after removing the entire transport for cleaning off line.

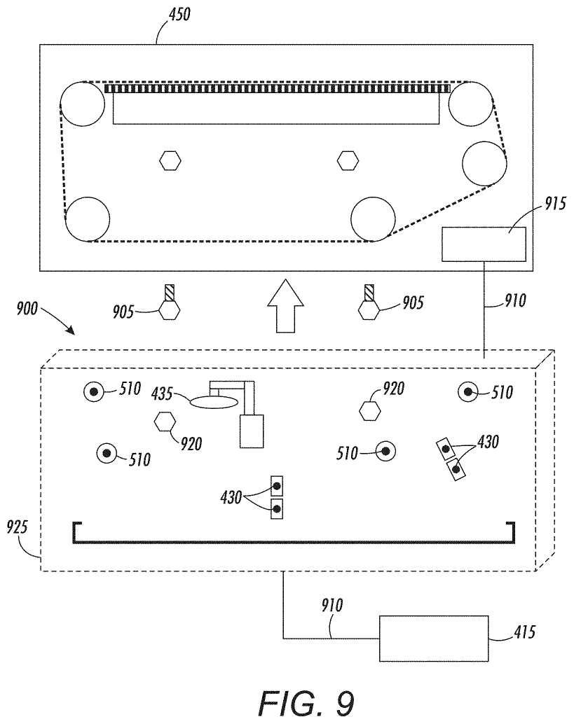

FIG. 9 illustrates a stand-alone cleaning station system 900 in accordance with the disclosed embodiments. The cleaning station system 900 is a separate unit from the onboard cleaning subsystem in the rendering device 450 that provides cleaning functions of for the complex belt transport mechanisms in advanced large format printers with large belt transports.

When cleaning is required, or preventative maintenance dictates, the rendering device 450 can be taken off-line or put into maintenance mode for service. The cover of the rendering device 450 can be removed and the cleaning station system 900 can be engaged on the rendering device 450. Once connected, the cleaning station system 900 can provide cleaning or maintenance functions which require little or no operator skill. Damage to internal subsystems of the rendering device 450 are minimized because removal of complex components is not required.

The cleaning station system 900 generally includes a cleaning system housing 925 with one or more fittings 905 configured to engage mounts 920 to like mounting points on the rendering device 450. It should be understood that the cleaning station system 900 can be configured to engage multiple types of rendering devices, or can have fitting patterns that are precisely organized for a specific rendering device.

In certain embodiments, the cleaning station system 900 can include one or more of the elements illustrated in the embodiments shown in FIGS. 4-8. To avoid contamination in neighboring areas of the rendering machine's ducts, drain shields and splash guards can be fitted to the rendering device to mitigate drips and overspray.

By precisely docking and locking the cleaning station system 900 into place while performing maintenance and/or cleaning, space within the rendering device 450 to which the operator has access can be minimized.

The cleaning station system 900 can further include an attachment 910 to the control system 415, or to the control system 915 of the rendering device 450 or to an associated computer system 105. The cleaning station system 900 can interface electronically with the rendering device 450 or computer system controls to advance the belts, operate the rollers, operate the wipers, operate the air knifes, or operate other rendering device 450 components as necessary. For example, the cleaning station system 900 can reverse direction and/or engage/disengage media path features to facilitate effective cleaning and/or maintenance.

Consumable materials such as cleaning solutions, other liquids, wipers and waste handling can all be contained in the stand-alone cleaning station system 900 and can be refillable and/or disposable as necessary. Most commonly, refilling consumables and removing disposables can occur while the cleaning station system 900 is not being used for cleaning or maintenance.

It should be understood that, while the embodiments can be used without removal of components of the rendering device 450, in other embodiments the cleaning station system 900 can be used after complete removal of the belt transport module. In such a case, the module is cleaned outside of the rendering device 450 without removing the belt.

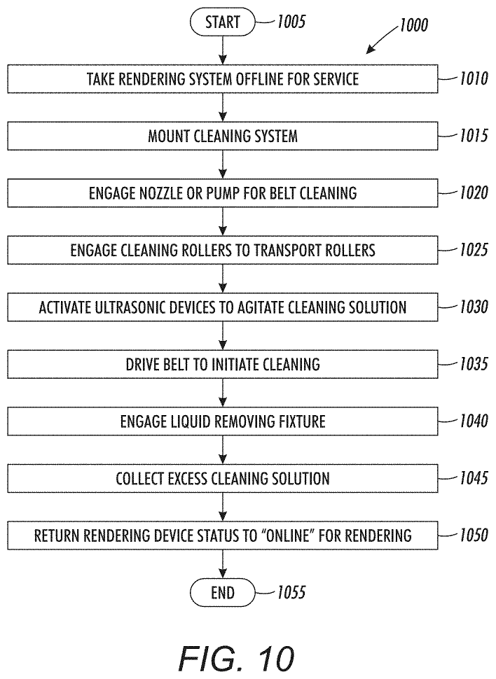

FIG. 10 illustrates a method 1000 for in-situ cleaning of rendering devices in accordance with the disclosed embodiments. The method begins at 1005.

At step 1010, the rendering device 450, which can comprise a printer, multi-function device, or other such device, can be taken offline for service. In some embodiments, where cleaning systems disclosed herein are internally provided (e.g. cleaning system 400) in the rendering device 450, this step can be as simple as temporarily suspending rendering operations and initiating a cleaning operation. In embodiments where the system is an externally housed system (e.g. cleaning station system 900) this can include both suspending rendering operations, removing a cover to the rendering device 450, and mounting the cleaning system housing 925 as shown at step 1015.

Next, at step 1020, the liquid dispensing apparatus can be engaged. In some embodiments, this can comprise engaging a shower 435 or nozzle as disclosed herein. In other embodiments, this can comprise engaging a wave producing system as disclosed in FIGS. 7-8. In either case, the liquid dispensing system includes a pump and conduit assembly 460 (or pump 715) configured to pump cleaning solution 425 to a shower 435, or through a wave-creating ducted output structure 720, such that cleaning solution 425 is dispensed on a belt 405 in the rendering device 450. Similarly, at step 1025, cleaning rollers 510 associated with the cleaning system 400 can be engaged to the transport rollers 410 in the rendering device 450. In certain embodiments, this can include adjusting the positioning of the cleaning rollers 510 to be in physical contact with one or more of the transport rollers 410 in the rendering device 450.

At step 1030, ultrasonic devices 505 disposed in cleaning solution 425 can likewise be activated in order to agitate and/or mist the cleaning solution 425. In some embodiments, the cleaning solution 425 can be held in the marker transport 465. Agitation of the cleaning solution 425 held therein, creates small ripples such that cleaning solution 425 comes in contact with the marker transport 465.

With the various cleaning components engaged, at step 1035, the belt 405 of the rendering device 450 can be driven so that cleaning solution 425 comes in contact with belt 405 as it passes. In addition, the transport rollers 410 in the rendering device 450 spin as the belt 405 moves (and in some cases one or more of the transport rollers drives the belt movement). As the transport rollers 410 spin, the cleaning surface on the cleaning rollers 510 cleans the transport rollers 410. The systems can be configured to drive the belt 405 in its standard operating direction, or in the opposite direction if desired. The belt 405 can be driven in a specific pattern if desired (e.g. the belt 405 can move very slowly, or can stop intermittently to ensure sufficient cleaning solution 425 contacts the belt 405).

At step 1040, the dryer 430 (or other such liquid removing fixture or fixtures) can be engaged. These dryers 430 serve to dry the belt 405 and/or remove excess cleaning solution 425 from the belt 405. The excess cleaning solution 425 can be collected at step 1045, for example in a drip pan 440. It should be noted that, in certain embodiments, the excess cleaning solution 425 can be pumped back to a reservoir 420 for reapplication in the cleaning method. Once the cleaning solution 425 is sufficiently soiled, it can be disposed of via a drain 455.

Cleaning system operation can continue until the belt 405, transport rollers 410, and marker transport 465 are sufficiently clean and sufficiently dried. Once the cleaning cycle is complete, the rendering device 450 can be returned to an online mode, as illustrated at step 1050, which indicates it is ready to resume rendering operations. The method ends at 1055.

According to such systems and methods effective cleaning of a rendering device can be performed as necessary; for example, between jobs or setups. The systems and methods offer substantial cost benefits over traditional cleaning solutions. The cleaning algorithms can be consistent, repeatable, and normalized so that less user to user variability is introduced in the cleaning process. The system also provides in place cleaning that does not require removal of belt transport components.

Based on the foregoing, it can be appreciated that a number of embodiments, preferred and alternative, are disclosed herein. For example, in one embodiment, an in-situ cleaning system comprises a shower configured to dispense cleaning solution on a belt; a dryer configured down line from the shower, and at least one cleaning roller configured to engage a transport roller associated with the belt. The system can further comprise at least one ultrasonic device disposed in cleaning solution associated with a transport.

In an embodiment, the system can further comprise a controller the controller comprising: at least one processor, and a computer-usable medium embodying computer program code, the computer-usable medium capable of communicating with the at least one processor, the computer program code comprising instructions executable by the at least one processor and configured for controlling at least one of: dispensation associated with the shower; operation of the dryer; engagement of the at least one cleaning roller; and operation of the ultrasonic device.

In an embodiment the controller can operate in one of: an automatic mode and a manual mode.

In an embodiment, the dryer comprises one of: a wiper, an air knife, and a vacuum.

In an embodiment, the system can further comprise a drip pan configured beneath the belt to collect residual cleaning solution and a pump disposed in the drip pan configured to pump the residual cleaning solution to the shower.

In an embodiment, the at least one cleaning roller further comprises: a rotational hub, an interior body, and an exterior cleaning surface.

In an embodiment, the system can further comprise a housing wherein the shower, the dryer, and the at least one cleaning roller are housed and at least one mounting fixture for fixedly mounting the housing to a rendering device. In an embodiment, the belt comprises a transport belt associated with a rendering device.

In another embodiment, a method for in-situ cleaning comprises dispensing a cleaning solution on a belt, removing the cleaning solution from the belt with a dryer configured down line from the dispensed cleaning solution, and cleaning a transport roller with at least one cleaning roller engaged against the transport roller.

In an embodiment, the method further comprises agitating cleaning solution disposed in a marker transport with at least one ultrasonic device.

In an embodiment, the method further comprises controlling, with a controller, at least one of: dispensation associated with the shower; operation of the dryer; engagement of the at least one cleaning roller; and operation of the ultrasonic device. In an embodiment, the controller can operate in one of an automatic mode and a manual mode.

In an embodiment, the dryer comprises one of: a wiper, an air knife, and a vacuum.

In an embodiment, the method further comprises collecting residual cleaning solution with a drip pan configured beneath the belt, and pumping the collected residual cleaning solution to a reservoir with a pump disposed in the drip pan.

In an embodiment, the at least one cleaning roller further comprises a rotational hub, an interior body, and an exterior cleaning surface.

In an embodiment, the method further comprises mounting a housing wherein the reservoir, the dryer, and the at least one cleaning roller are housed to a rendering device.

In another embodiment, a system comprises a cleaning solution reservoir filled with cleaning solution, a ducted output structure configured in the cleaning solution reservoir, and a pump configured to pump cleaning solution in the cleaning solution reservoir through an opening of the ducted output structure wherein the cleaning solution exiting the ducted output structure contacts a belt. In an embodiment the system further comprises a dryer downline from the ducted output structure. In an embodiment, the dryer comprises one of a wiper, an air knife, and a vacuum.

It will be appreciated that variations of the above-disclosed and other features and functions, or alternatives thereof, may be desirably combined into many other different systems or applications. Also, it should be understood that various presently unforeseen or unanticipated alternatives, modifications, variations or improvements therein may be subsequently made by those skilled in the art which are also intended to be encompassed by the following claims.

What is claimed is:

1. An in-situ cleaning system comprising:
a shower configured to dispense cleaning solution on a belt;
a dryer configured down line from said shower; and
at least one cleaning roller configured to engage a transport roller associated with said belt.

2. The in-situ cleaning system of claim 1 further comprising:
at least one ultrasonic device disposed in cleaning solution associated with a transport.

3. The in-situ cleaning system of claim 2 further comprising:
a controller said controller comprising:
at least one processor; and
a computer-usable medium embodying computer program code, said computer-usable medium capable of communicating with said at least one processor, said computer program code comprising instructions executable by said at least one processor and configured for controlling at least one of:
dispensation associated with said shower;
operation of said dryer;
engagement of said at least one cleaning roller; and
operation of said at least one ultrasonic device.

4. The in-situ cleaning system of claim 3 wherein said controller can operate in one of:
an automatic mode; and
a manual mode.

5. The in-situ cleaning system of claim 1 wherein said dryer comprises one of:
a wiper;
an air knife; and
a vacuum.

6. The in-situ cleaning system of claim 1 further comprising:
a drip pan configured beneath said belt to collect residual cleaning solution; and
a pump disposed in said drip pan configured to pump said residual cleaning solution to said shower.

7. The in-situ cleaning system of claim 1 wherein said at least one cleaning roller further comprises:
a rotational hub;
an interior body; and
an exterior cleaning surface.

8. The in-situ cleaning system of claim 1 further comprising:
a housing wherein said shower, said dryer, and said at least one cleaning roller are housed; and
at least one mounting fixture for fixedly mounting said housing to a rendering device.

9. The in-situ cleaning system of claim 1 wherein said belt comprises a transport belt associated with a rendering device.

10. A method for in-situ cleaning comprising:
dispensing a cleaning solution on a belt;
removing said cleaning solution from said belt with a dryer configured down line from said dispensed cleaning solution; and
cleaning a transport roller with at least one cleaning roller engaged against said transport roller.

11. The method of claim 10 further comprising:
agitating cleaning solution disposed in a marker transport with at least one ultrasonic device.

12. The method of claim 11 further comprising:
controlling, with a controller, at least one of:
dispensation associated with said shower;
operation of said dryer;
engagement of said at least one cleaning roller; and
operation of said at least one ultrasonic device.

13. The method of claim 12 wherein said controller can operate in one of:
an automatic mode; and
a manual mode.

14. The method of claim 10 wherein said dryer comprises one of:
a wiper;
an air knife; and
a vacuum.

15. The method of claim 10 further comprising:
collecting residual cleaning solution with a drip pan configured beneath said belt; and
pumping said collected residual cleaning solution to a reservoir with a pump disposed in said drip pan.

16. The method of claim 10 wherein said at least one cleaning roller further comprises:
a rotational hub;
an interior body; and
an exterior cleaning surface.

17. The method of claim 10 further comprising:
mounting a housing wherein a drip pan, said dryer, and said at least one cleaning roller are housed, to a rendering device.

18. A system comprising:
a cleaning solution reservoir filled with a cleaning solution;
a ducted output structure configured in said cleaning solution reservoir; and
a pump configured to pump cleaning solution in said cleaning solution reservoir through an opening of said ducted output structure wherein said cleaning solution exiting said ducted output structure contacts a belt.

19. The system of claim 18 further comprising:
a dryer downline from said ducted output structure;

20. The system of claim 19 wherein said dryer comprises one of:
a wiper;
an air knife; and
a vacuum.
